(19) United States
(12) Patent Application Publication
(10) Pub. No.: US 2026/0367632 A1
(43) Pub. Date: Nov. 19, 2026

(54) NAVIGATION CONTROL OF AUTONOMOUS UNMANNED AERIAL VEHICLE (UAV)

(71) Applicant: The Regents of the University of Michigan, Ann Arbor, MI (US)

(72) Inventors: Behdad Davoudi, Ann Arbor, MI (US); Karthik Duraisamy, Ann Arbor, MI (US)

(21) Appl. No.: 19/106,173

(22) PCT Filed: Aug. 24, 2023
(86) PCT No.: PCT/US2023/031009

§ 371 Date: Feb. 24, 2025

Related U.S. Application Data
(60) Provisional application No. 63/400,460, filed on Aug. 24, 2022.

(51) Int. Cl. G05D 1/606; B64U 20/80; G05D 109/25

(52) U.S. Cl. CPC G05D 1/606; B64U 20/80; B64U 2201/10; G05D 2109/254

(57) ABSTRACT

Controlling navigation of an autonomous unmanned aerial vehicle (UAV), commonly known as a drone, involves mathematical modeling and the resulting estimations. The autonomous UAV has one or more rotors, a wind sensor, and a controller for feedforward flight control implementation, per an embodiment. One estimation is of a thrust force at the rotor(s), and another estimation is of a rotor drag force at the rotors(s). Further, the wind sensor takes wind measurements. The wind measurements, the thrust force estimation, and the rotor drag force estimation are all used by the feedforward flight control in order to control navigation of the autonomous UAV. The navigation control can more readily manage flight of the autonomous UAV amid strong crosswinds, wind gusts, heavy winds, and other severe environmental conditions.

### TECHNICAL FIELD

This disclosure relates generally to unmanned aerial vehicles (UAVs) and, more particularly, relates to navigation control of UAVs in an autonomous manner.

### BACKGROUND

Operational capabilities of autonomous unmanned aerial vehicles (UAVs)—more commonly known as drones—are advancing swiftly. Autonomous unmanned aircraft systems (UASs) employ UAVs in a number of applications and for various purposes. Applications include civilian, commercial, military, recreational, and agricultural, among many others. UAVs may be used for aerial photography and filming, package and product deliveries, infrastructure inspections, policing and surveillance, military missions, as well as for other purposes. But the unpredictable nature of extreme and severe environmental conditions that can be encountered during flight—such as sudden and strong crosswinds and wind gusts, as well as local turbulent winds—remain a challenge to the operation of autonomous UAVs. Destabilization of flight and even failure in certain cases can occur. This is especially true for some under-actuated and under-powered UAVs that often lack the faculty to compensate for such miscues. Past efforts to model UAV rotor aerodynamics have demanded extensive computational resources and hence are impractical for onboard execution, or alternatively exhibit a fidelity that is lower than what is needed to model the aerodynamics and manage unpredictable and extreme environments in an effective manner.

### SUMMARY

According to an aspect of the disclosure, a method of controlling navigation of an autonomous unmanned aerial vehicle (UAV) may have several steps. The method may involve providing the autonomous UAV with one or more rotors, a wind senor, and a controller. The method may involve estimating a thrust force at the rotor(s). The estimation of the thrust force involves geometric properties of the rotor(s). The method may also involve taking wind measurements by way of the wind sensor. Yet further, the method may involve controlling navigation of the autonomous UAV with the use of feedforward flight control and based in part or more upon the estimated thrust force and the wind measurements taken.

According to another aspect of the disclosure, an autonomous unmanned aerial vehicle (UAV) may include one or more rotors, a wind sensor, and a controller. The wind sensor is carried by the autonomous UAV. The controller uses feedforward flight control and is carried by the autonomous UAV. The feedforward flight control employs a first physics-based mathematical model in order to estimate a thrust force at the rotor(s). The feedforward flight control employs a second physics-based mathematical model in order to estimate a rotor drag force at the rotor(s). The estimation of the thrust force involves geometric properties of the rotor(s), and the estimation of the rotor drag force involves geometric properties of the rotor(s). The feedforward flight control uses wind measurements received from the wind sensor and uses the first physics-based mathematical model and the second physics-based mathematical model in order to provide flight control commands for navigation of the autonomous UAV.

According to yet another aspect of the disclosure, a method of controlling navigation of an autonomous unmanned aerial vehicle (UAV) may have several steps. The method may involve providing the autonomous UAV with one or more rotors, a wind sensor, and a controller. The method may involve estimating a thrust force of the autonomous UAV at the rotor(s). Estimating the thrust force is performed onboard the autonomous UAV. The method may also involve estimating a rotor drag force of the autonomous UAV at the rotor(s). Estimating the rotor drag force is performed onboard the autonomous UAV. The method may further involve measuring wind by way of the wind sensor. And, the method may involve controlling navigation of the autonomous UAV with the use of feedforward flight control at the controller and based in part or more upon the estimated thrust force, the estimated rotor drag force, the wind measurements, and a formulated relationship between RPM measurements and corresponding throttle input data.

### BRIEF DESCRIPTION OF THE DRAWINGS

Exemplary embodiments will hereinafter be described in conjunction with the appended drawings, wherein like designations denote like elements, and wherein;

FIG. 1 is a schematic of an unmanned aerial vehicle (UAV) showing a thrust force (T) representation, a rotor drag force (F_{D}) representation, and a parasite drag (Dₚ) representation;

FIG. 2 is a depiction of flow geometry associated with an airfoil section of a blade of an individual rotor;

FIG. 3 is a depiction of momentum theory for an example rotor disk;

FIG. 4 is a graph of propeller chord (centimeters; cm) and twist angle (degrees) versus normalized span radial location (r/R);

FIG. 5 is a top view depiction of an example wind tunnel setup that may be used to measure a rotor drag force;

FIG. 6A is a graph of experimental results of thrust force (Newtons; N) versus advance ratio (μ) for a wind tunnel speed of V_{∞}=5 meters per second (m/s);

FIG. 6B is a graph of experimental results of thrust force (Newtons; N) versus advance ratio (μ) for a wind tunnel speed of V_{∞}=10 meters per second (m/s);

FIG. 6C is a graph of experimental results of thrust force (Newtons; N) versus advance ratio (μ) for a wind tunnel speed of V_{∞}=15 meters per second (m/s);

FIG. 7A is a graph of experimental results of rotor drag force (Newtons; N) versus rotor angle of attack (α_{R}; degrees) for a wind tunnel speed of V_{∞}=5 meters per second (m/s);

FIG. 7B is a graph of experimental results of rotor drag force (Newtons; N) versus rotor angle of attack (α_{R}; degrees) for a wind tunnel speed of V_{∞}=10 meters per second (m/s);

FIG. 7C is a graph of experimental results of rotor drag force (Newtons; N) versus rotor angle of attack (α_{R}; degrees) for a wind tunnel speed of V_{∞}=15 meters per second (m/s);

FIG. 8A is a graph of experimental results of rotor drag force (Newtons; N) versus advance ratio (μ) for a wind tunnel speed of V_{∞}=5 meters per second (m/s);

FIG. 8B is a graph of experimental results of rotor drag force (Newtons; N) versus advance ratio (μ) for a wind tunnel speed of V_{∞}=10 meters per second (m/s);

FIG. 8C is a graph of experimental results of rotor drag force (Newtons; N) versus advance ratio (μ) for a wind tunnel speed of V_{∞}=15 meters per second (m/s);

FIG. 9A is a graph of experimental results of a relationship of rotor revolutions per minute (RPM) versus throttle input for a wind tunnel speed of V_{∞}=5 meters per second (m/s);

FIG. 9B is a graph of experimental results of a relationship of rotor revolutions per minute (RPM) versus throttle input for a wind tunnel speed of V_{∞}=10 meters per second (m/s);

FIG. 9C is a graph of experimental results of a relationship of rotor revolutions per minute (RPM) versus throttle input for a wind tunnel speed of V_{∞}=15 meters per second (m/s);

FIG. 10 depicts an embodiment of an autonomous unmanned aerial vehicle (UAV) with a wind sensor;

FIG. 11 is a schematic of an embodiment of a communication and information circulation setup for autonomous position control;

FIG. 12A is a schematic demonstrating certain forces applied to an autonomous UAV of the quadrotor type that is subject to a strong crosswind on an arbitrary path;

FIG. 12B is a schematic demonstrating certain forces applied to the autonomous UAV of the quadrotor type that is subject to a strong crosswind on an arbitrary path;

FIG. 13 shows an embodiment of a wind sensor that can be used with an autonomous UAV;

FIG. 14 is a schematic of an example experimental setup;

FIG. 15 is a graph of experimental results of position and trajectory tracking with X-position (meters; m) on a y-axis and Y-position (meters; m) on an x-axis;

FIG. 16A is a graph of experimental results of position tracking with X-position (meters; m) on a y-axis and time (seconds; s) on an x-axis;

FIG. 16B is a graph of experimental results of position tracking with Y-position (meters; m) on a y-axis and time (seconds; s) on an x-axis; and

FIG. 16C is a graph of experimental results of position tracking with Z-position (meters; m) on a y-axis and time (seconds; s) on an x-axis.

### DETAILED DESCRIPTION

Embodiments of an autonomous unmanned aerial vehicle (UAV) and embodiments of a method of controlling navigation of the autonomous UAV are presented. The autonomous UAV can be part of a larger unmanned aircraft system (UAS). In certain embodiments presented in this description, the autonomous UAV utilizes feedforward flight controls, wind sensing, and force estimations and predictions of rotor aerodynamics in order to enhance operation of the autonomous UAV and, according to flight experiments and tests conducted, more accurately follow an intended trajectory. A revolutions per minute (RPM) and throttle input relationship attributed to rotors of the autonomous UAV may also be utilized in navigation control according to an embodiment. The estimations of force employ physics-based mathematical modeling that exhibits effective fidelity and efficient computational performance for onboard execution—an opportune association unrealized in past efforts. The method of navigation control may be particularly useful in flight amid extreme and severe environmental conditions such as sudden and strong crosswinds and wind gusts, as well as local turbulent winds. The autonomous UAV and navigation control method described herein have expansive applications and purposes including, but not limited to, civilian, commercial, military, recreational, and agricultural applications, and for use in aerial photography and filming, package and product deliveries, infrastructure inspections, policing and surveillance, and military missions. For agricultural applications, as an example, the autonomous UAV and navigation control method can be employed for more precise pesticide spraying procedures, as well as other agricultural chemical and solution spraying procedures.

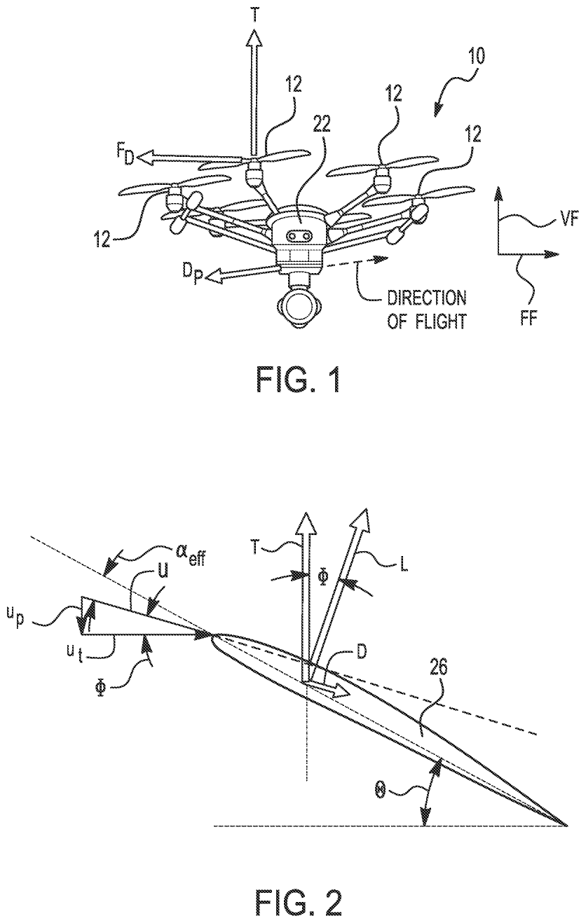

The autonomous UAV and method of controlling navigation of the autonomous UAV can vary in different embodiments depending upon, among other possible factors, the design and construction and components of the autonomous UAV itself and the intended flight application and purpose. It will become apparent to skilled artisans as this description advances that the autonomous UAV could have more, less, and/or different components than those set forth with reference to the figures and described herein, and that the method could have more, less, and/or different steps than those described herein. With reference to FIGS. 1 and 10, an embodiment of an autonomous UAV 10 is presented. According to this embodiment, the autonomous UAV 10 includes multiple rotors 12, a wind sensor 14, and a controller 16. While this embodiment of the autonomous UAV 10 is presented as a rotary-wing type autonomous UAV with multiple rotors, the autonomous UAV could be a fixed-wing type autonomous UAV with a single rotor or multiple rotors in other embodiments; in this regard, the term autonomous UAV, as used herein, is intended to have an expansive meaning to encompass both rotary-wing type autonomous UAVs and fixed-wing type autonomous UAVs.

The rotors 12 serve to furnish propulsion and control of the autonomous UAV 10. The rotors 12 are equipped on, and extend from, a body and frame 22 of the autonomous UAV 10. Depending on the type of UAV, the quantity of individual rotors, size and shape of rotors, location of rotors with respect to one another and relative to the body and frame 22, as well as other designs and constructions and configurations of the rotors 12, can vary in different embodiments. In the embodiment of FIG. 10, for example, the autonomous UAV 10 is of the rotary-winged and multi-rotor type, and more particularly is a quadrotor autonomous UAV. There are four individual rotors 12 in total. The four rotors 12 are arranged in an X-configuration according to this embodiment. The rotors 12 are driven to rotate and spin during fight of the autonomous UAV 10 by electric motors, as will be appreciated by skilled artisans. Still, the autonomous UAV 10 could have other quantities of rotors and other configurations in other embodiments, among various possibilities apart from those set forth herein.

The wind sensor 14 serves to take wind speed measurements amid flight of the autonomous UAV 10. The wind measurements are electrically communicated to the controller 16 and received thereby as an input for navigation control of the autonomous UAV 10, according to certain embodiments. As described in more detail below, the wind sensor 14 and its wind measurements provide active sensing for the force estimations of rotor aerodynamics, and the wind measurements are employed in the physics-based mathematical modeling that takes place. Moreover, in certain embodiments, the wind sensor 14 measures both horizontally-directed wind speed and vertically-directed wind speed, and electrically communicates the horizontally- and vertically-directed wind speed measurements to the controller 16 for employment in the physics-based modeling and navigation control of the autonomous UAV 10.

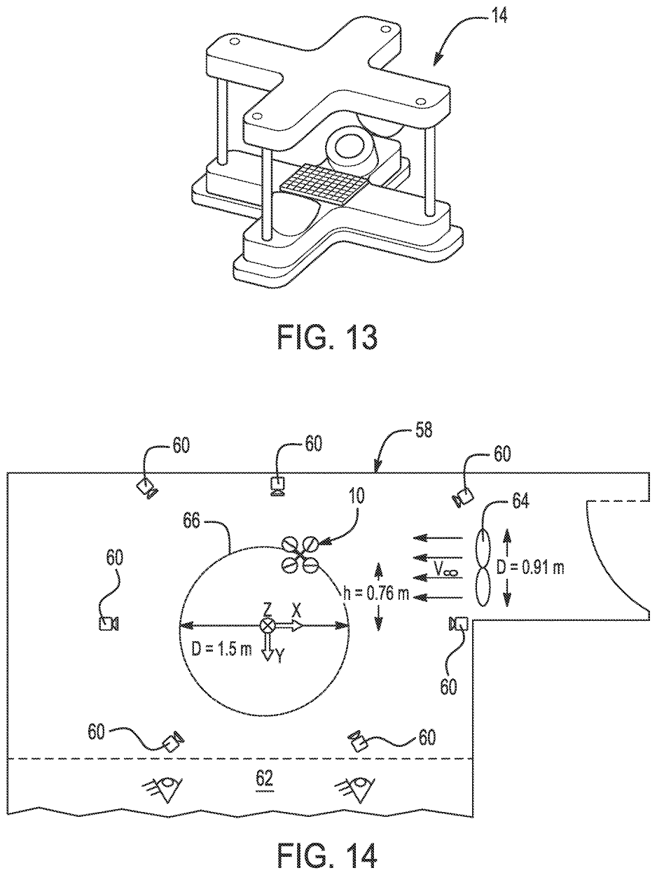

With continued reference to FIG. 10, the wind sensor 14 can extend from the body and frame 22, and can be carried thereby. In this regard, the wind sensor 14 constitutes an onboard wind sensor with respect to the autonomous UAV 10. The wind sensor 14 is intended to sense wind conditions acting on the autonomous UAV 10 and impacting its flight trajectory. The proximity of the wind sensor 14 relative to the body and frame 22 can vary in different embodiments. In FIG. 10, the wind sensor 14 is supported atop an upright 24 and is thereby located vertically above the body and frame 22 of the autonomous UAV 10. The upright 24 can be lightweight. In this example, the wind sensor 14 is located approximately ten inches (twenty-five centimeters; 25 cm) above the rotors 12; this location according to this example was found to diminish unwanted rotor inflow stream influences on the wind sensor's readings. Still, the wind sensor 14 could have other mountings and other locations in other embodiments. Further, the wind sensor 14 can be of different types, depending on the embodiment. With reference to FIGS. 10 and 13, in this example the wind sensor 14 is of the ultrasonic wind sensor type. A more specific example is the TriSonica™ Mini wind and weather sensor provided by Anemoment LLC of Longmont, Colorado, USA—indeed, this is the sensor illustrated in FIG. 13. The sensor is lightweight, weighing approximately fifty grams (50 gm), and can measure wind speed in three directions (e.g., x-direction, y-direction, and z-direction). Table 1 presents certain manufacturer specifications:

TABLE 1

| | Wind Speed | Wind Direction |
|---|---|---|
| Range | 0-50 m/s | For x and y: 0-360°, For z: ±30° |
| Resolution | For 0-10 m/s: 0.1 m/s | 1.0° |
| Accuracy | For 0-10 m/s: ±0.1 m/s | ±1.0° |

Still, other wind sensors exhibiting other specifications and from other companies may be suitable in other embodiments.

The controller 16 manages at least some aspects of navigation and flight trajectory control amid at least some modes of use of the autonomous UAV 10. Flight control commands and signals, which may be part of a larger flight scheme, can be initiated by the controller 16. Flight software can be incorporated into the controller 16. The controller 16 uses and implements feedforward flight control, according to this embodiment. Control can involve pitch (θ), roll (φ, φ), yaw (ψ), and throttle actions, for example, of the autonomous UAV 10 via manipulation of the rotors 12. Depending on the embodiment, feedforward flight control can be based upon one or more of the following inputs: the force estimations and predictions of rotor aerodynamics, the RPM and throttle input relationship, and/or the wind measurements received from the wind sensor 14. Adjustments and modifications to navigation and the flight control commands and signals made by the controller 16 can be in response to these inputs. Furthermore, management of navigation and flight trajectory control effected by feedforward flight control can be carried out in concert with feedback flight control, per certain embodiments of the autonomous UAV 10.

With reference to FIG. 10, in this embodiment the controller 16 is physically carried by the autonomous UAV 10 and by its body and frame 22. The controller 16 can be mounted onboard the body and frame 22. Management of navigation and flight trajectory control by way of the controller 16 and using feedforward flight control is hence performed and implemented onboard the autonomous UAV 10 itself. For example, the force estimations and predictions of rotor aerodynamics can be executed by the controller 16 and onboard the autonomous UAV 10 in the midst of flight—i.e., off-line and offboard executions of rotor aerodynamics are not performed according to this embodiment. The controller 16 can effect real-time execution of the force estimations and predictions of rotor aerodynamics, per this embodiment.

According to an embodiment, the controller 16 employs a first physics-based mathematical model in order to estimate a thrust force, and employs a second physics-based mathematical model in order to estimate a rotor drag force. The first and second physics-based mathematical models respectively yield estimated predictions of thrust force and rotor drag force. The thrust force and rotor drag force act on the autonomous UAV 10 during flight. In the case of a fixed-wing type autonomous UAV, the rotor drag force may not need to be estimated. Compared to past efforts, the modeling embodied by the first and second physics-based mathematical models exhibits effective fidelity and efficient computational performance for execution onboard the autonomous UAV 10, and for real-time execution. With reference now to FIG. 1, a thrust force (Newton, N) is represented by the arrowed line denoted T, and a rotor drag force is represented by the arrowed line denoted F_{D}. The thrust force T and rotor drag force F_{D} are exerted at each of the rotors 12 during flight of the autonomous UAV 10. As shown, in this flight orientation, the thrust force T is generally vertically-directed and the rotor drag force F_{D} is generally horizontally-directed. The thrust force T and rotor drag force F_{D} constitute aerodynamic forces at the rotors 12. Further, a parasite drag is represented by the arrowed line denoted Dₚ. The parasite drag Dₚ is produced as a consequence of resistance of the body and frame 22 to wind impingement thereagainst. The parasite drag Dₚ constitutes an aerodynamic force at the body and frame 22. In smaller-sized UAVs, the thrust force T and rotor drag force F_{D} are more dominant compared to the parasite drag Dₚ (N).

The first physics-based mathematical model is also referred to as a hybrid blade element momentum (HBEM) model. Still referring to FIG. 1, the first physics-based mathematical model, per an embodiment, yields estimated predictions of the thrust force T at the rotors 12 when the autonomous UAV 10 is travelling in forwardly-directed flight FF (i.e., edge-wise flight) and vertically-directed or axial flight VF (i.e., hover flight). In an example, and unlike past efforts, the estimated predictions of the thrush force T in the forwardly-directed flight FF exhibit effective fidelity and sufficient accuracy, and can be executed at a rate of approximately 200 Hertz (Hz) which has been determined to be suitable for onboard execution via the controller 16; still, other rates of execution may be possible in other examples. In general, the first physics-based mathematical model utilizes certain geometric properties of the rotors 12 in its estimation of the thrust force T. According to an embodiment, the geometric properties can include, but are not limited to, one or more of: blade twist angle (Θ), chord distribution, chord length (c (meters, m)), number of blades (N_{b}), rotor hub radius (rₘᵢₙ), and/or rotor radius (R (m)). Further, per an embodiment, the first physics-based mathematical model utilizes certain flight state parameters that can include, but are not limited to, Euler angles and velocity. The first physics-based mathematical model may additionally utilize revolutions per minute (RPM) of the rotors 12, which may be measured RPM sensor(s) 18, as set forth below. Alternatively, per an embodiment, the RPM of the rotors 12 can be estimated when thrust force T is provided as an input.

The first physics-based mathematical model, or HBEM model, has been found to satisfy both blade element theory (BET) and momentum theory. The first physics-based mathematical model employs a linear inflow model that has been found to be consistent with both the blade element and momentum theories. Blade element theory is employed to determine the thrust force T exerted by an individual rotor of the rotors 12 by integrating lift produced at every airfoil section of a blade 26 (FIG. 2) of the individual rotor 12. A lift coefficient

$$( {C}_{1} = \frac{L}{1 / 2 ρ {u}^{2} c} , where L is airflow sectional lift ( N / m ) )$$

for every blade section is determined using equation 1 below, with reference also to FIG. 2:

C₁(r,ψ)=C_{1α}(α_{eff}+α_{L=0}),

where the effective angle of attack is defined as α_{eff}=(Θ−Φ). A lift coefficient slope is denoted by C_{1α}. In an embodiment, for thin airfoils incorporated into individual rotors 12, C_{1α} can be assumed to be approximately 1.8π based on XFOIL calculations. An inflow angle (Φ) is the arctangent of a ratio of perpendicular to tangential non-dimensional velocities as in Φ=tan⁻¹(uₚ(r,Ψ)/uₜ(r,Ψ)), where r is a non-dimensional radial location, and a rotor azimuth angle of the individual rotor 12 is denoted by Ψ. The tangential velocity for every blade section and azimuth angle of the individual rotor 12 is given by uₜ=r+μ sin(ψ). The blade twist angle is Θ, and α_{L=0} is the absolute value of angle of attack where lift is zero. Per this embodiment, inflow ratio is the same as non-dimensional perpendicular velocity λ(r,Ψ)=uₚ(r,Ψ). In order to represent the airflow sectional lift L when the effective sectional angle of attack (α_{eff}) is high, a post-stall model can be employed. Furthermore, an integration of equation 1 yields the overall thrust force T of the individual rotor 12. The integration is presented in equation 3 below, particularly the first part of the righthand side.

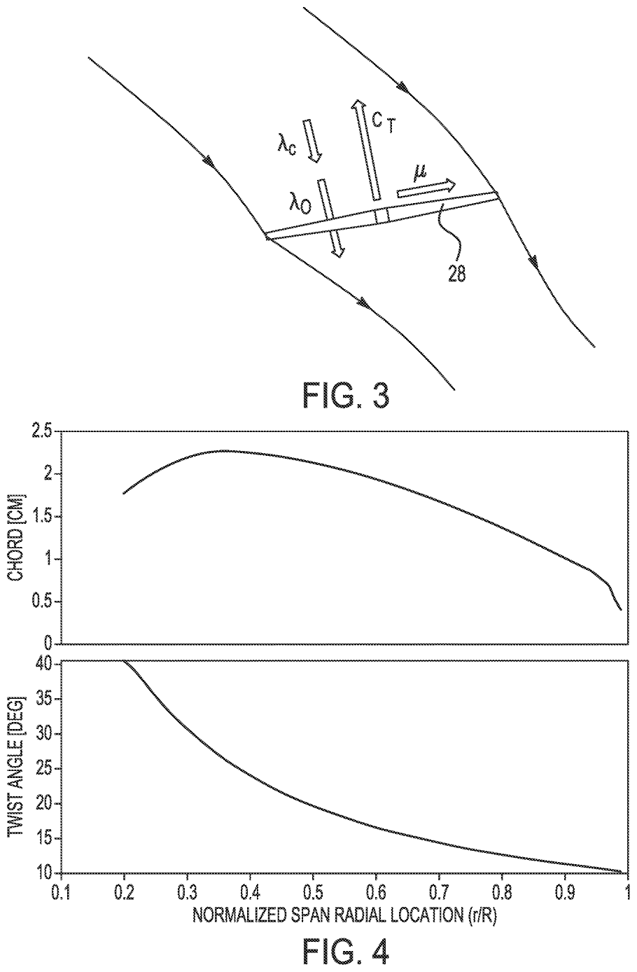

With reference now to FIG. 3, momentum theory observes conservation of energy for a stream tube that relates inflow velocity to the thrust force T. FIG. 3 is a depiction of momentum theory for an example rotor disk 28. Asa general matter, momentum theory lacks consideration of blade geometry of the rotors 12, and is not self-contained. Momentum theory is presented in equation 2 below, in non-dimensional form:

$${λ}_{0} = {λ}_{c} + \frac{{C}_{T}}{2 \sqrt{{μ}^{2} + {λ}_{0}^{2}}}$$

where λ_{c} is a climb ratio and μ is an advance ratio (^{q}vₓ²+v_{y}²/Vₜᵢₚ), both of which are set by the associated flight condition, and C_{T} is a thrust coefficient (T/(ρπR⁴ω²)). Further, λ₀ is a uniform inflow ratio. The first physics-based mathematical model combines momentum theory and blade element theory, assuming a linear inflow model (i.e., λ=λ₀(1+kₓr cos Ψ+k_{y}r sin Ψ) with kₓ=(15π/23)tan(tan⁻¹(μ/λ₀)/2) and k_{y}=0 in order to minimize the flowing error function and subsequently find the uniform inflow ratio (λ₀). The first physics-based mathematical model is presented in equation 3 below:

$$Err ( {λ}_{0} , μ , {λ}_{c} ) = \frac{{N}_{b}}{4 R {π}^{2}} {\int }_{{r}_{min}}^{1} {\int }_{0}^{2 π} {C}_{1} ( r , ψ ) [ {u}_{t}^{2} ( ( r , ψ ) + {λ}^{2} ( r , ψ ) ] c ( r ) cos ( Φ ) d Ψdr - 2 ( {λ}_{0} - {λ}_{c} ) \sqrt{{μ}^{2} + {λ}_{0}^{2}}$$

where c(r) is rotor chord length at non-dimensional radial location r, N_{b} is number of blades, and ρ is air density (kg m⁻³). Further, rₘᵢₙ is rotor hub, R is tip radii, and λ is a rotor inflow ratio. In equation 3 of the first physics-based mathematical model, blade element theory is represented by the former portion of the equation, namely

$$\frac{{N}_{b}}{4 R {π}^{2}} … d Ψdr .$$

Also, in equation 3 of the first physics-based mathematical model, momentum theory is represented by the latter portion of the equation, namely

$$2 ( {λ}_{0} - {λ}_{c} ) \sqrt{{μ}^{2} + {λ}_{0}^{2}} .$$

According to an embodiment, it has been found that the determination of a unique uniform inflow ratio λ₀ that satisfies both blade element and momentum theories can constitute a key step. Then, the thrust force T and RPM of the rotors 12 can be obtained provided a thrust force and RPM condition using either blade element theory or momentum theory. In blade element theory, in particular, uniform inflow ratio λ₀ is embedded in C₁, λ, and Φ that can be expanded as Φ=tan⁻¹[λ₀(1+kₓr cos Ψ+k_{y}r sin Ψ)/uₜ(r, Ψ)].

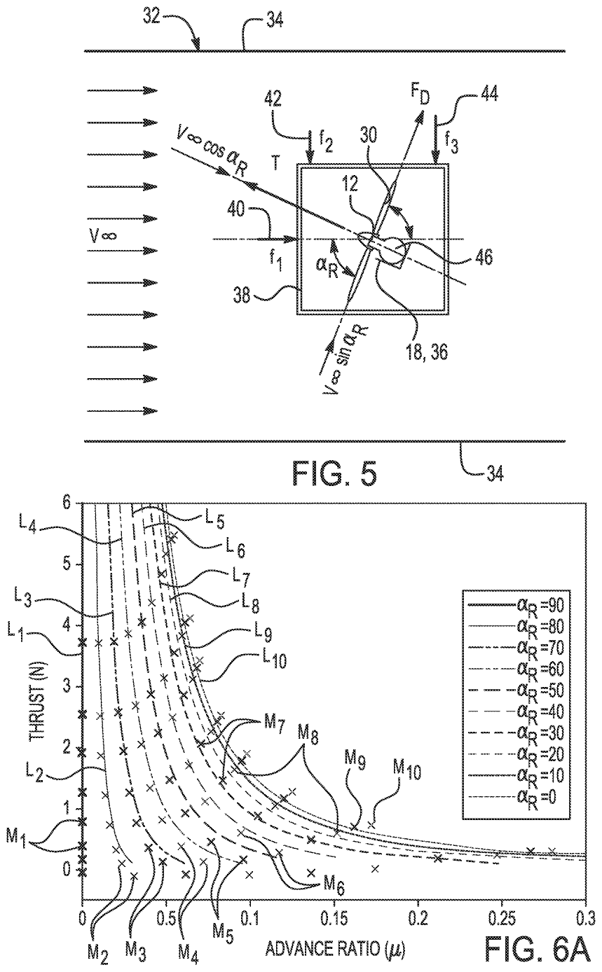

Wind tunnel experiments were conducted in order to validate the first physics-based mathematical model. In an example experiment, a propeller 30 (FIG. 5) of an individual rotor 12 has a propeller diameter of eight inches (8 in.) and has a pitch of 4.5 inches. In the example, the propeller 30 was a multi-rotor propeller provided by the APC Propellers company (www.apcprop.com) under the product describer 8×4.5MR; still, other propellers exhibiting other specifications and from other companies may be suitable in other examples and in other experiments. In the example experiment here, and with reference to FIG. 5, the propeller 30 was placed in a wind tunnel 32 measuring two feet by two feet (2 ft×2 ft). The wind tunnel 32 had wind tunnel walls 34. An optic sensor 36 was equipped adjacent the propeller 30 in order to measure revolutions per minute (RPM) of the propeller 30 amid experimentation. The optic sensor 36 can constitute the RPM sensor(s) 18. A force transducer frame 38 was installed at a location outside of the wind tunnel 32, and interacted with a first, second, and third force transducer 40, 42, 44. A vertical rod 46 extended from the propeller 30 at an interior of the wind tunnel 32 to the force transducer frame 38 at an exterior of the wind tunnel 32. The rod 46 constituted a direct connection between the propeller 30 and the force transducer frame 38. Forces exerted by the rotor 12 and by the propeller 30 amid experimentation were hence transferrable to, and capturable by, the first, second, and third force transducers 40, 42, 44 via the rod 46. The first, second, and third force transducers 40, 42, 44 were calibrated using known weights applied in different directions, with the coupling among the first, second, and third force transducers 40, 42, 44 having been taken into account in the calibration procedure.

In the example experiment, the propeller 30 was exposed to free stream (i.e., wind tunnel) velocities V_{∞} of 5 meters per second (m/s), 10 m/s, and 15 m/s. FIG. 4 presents the propeller chord (centimeters, cm) and twist angle (degrees) as a function of normalized span radial location (r/R) for the example propeller 30 according to this experiment. The rotation rate of the propeller 30 was altered by applying a range of throttle values from 0.2 to 0.9 with 0.1 increments. The RPM of the propeller 30 was measured via the optic sensor 36. Stream-wise and span-wise forces were measured by the first and second and third force transducers 40, 42, 44, denoted in FIG. 5 by f₁, f₂, and f₃. A rotor angle of attack (α_{R}) was altered from zero to ninety degrees (0°-90°), and for every angle of attack the throttle value was changed by 0.1 and from 0.2 to 0.9. Data were collected for every case for a total of twenty seconds (20 sec) and temporarily averaged. The thrust force T and rotor drag force F_{D} were obtained using the force balance presented in equations 4 below.

ΣF_{X}=T sin α_{R}−f₁−F_{D} cos α_{R}=0,

ΣF_{y}=T cos α_{R}+F_{D} sin α_{R}−f₂−₃=0,

⇒F_{D}=(f₂+f₃)sin α_{R}−f₁ cos α_{R},

⇒T=f₁ sin α_{R}+(f₂+f₃)cos α_{R}.

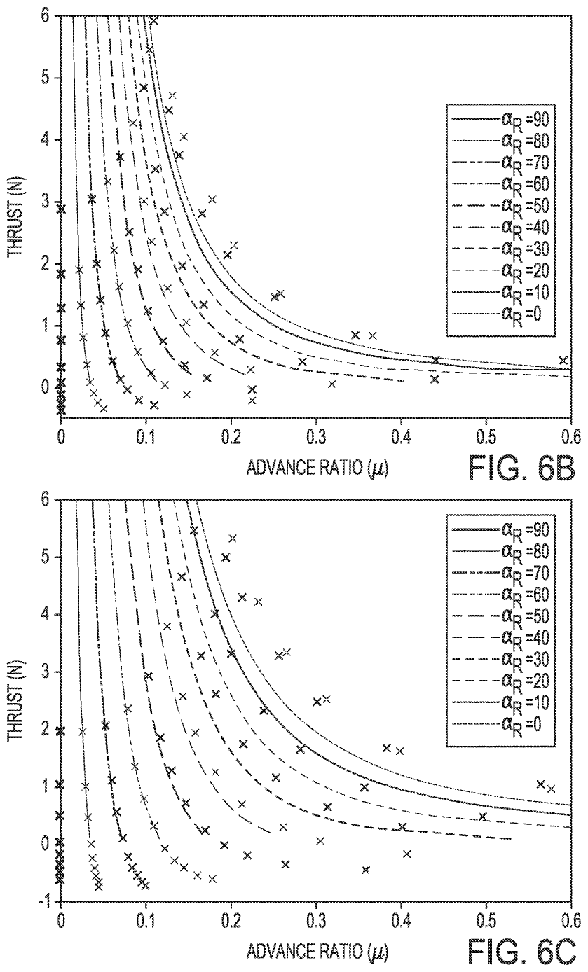

FIGS. 6A-6C present results in graphical form of the example experiments described above with reference to FIG. 5; still, skilled artisans should appreciate that other experiments may yield varying results. In the graphs, thrust force T (Newtons; N) is plotted on a y-axis and advance ratio (μ) is plotted on an x-axis. FIG. 6A exhibits experimental results for wind tunnel speed of V_{∞}=5 m/s; FIG. 6B exhibits experimental results for wind tunnel speed of V_{∞}=10 m/s; and FIG. 6C exhibits experimental results for wind tunnel speed of V_{∞}=15 m/s. Thrust force estimations and predictions of the first physics-based mathematical model are indicated generally in FIGS. 6A-6C by “x” marks. Furthermore, in the graphs of FIGS. 6A-6C, experimental results for a rotor angle of attack (α_{R}) of ninety degrees (90°) are designated by line L₁; experimental results for a rotor angle of attack (α_{R}) of eighty degrees (80°) are designated by line L₂; experimental results for a rotor angle of attack (α_{R}) of seventy degrees (70°) are designated by line L₃; experimental results for a rotor angle of attack (α_{R}) of sixty degrees (60°) are designated by line L₄; experimental results for a rotor angle of attack (α_{R}) of fifty degrees (50°) are designated by line L₅; experimental results for a rotor angle of attack (α_{R}) of forty degrees (40°) are designated by line L₆; experimental results for a rotor angle of attack (α_{R}) of thirty degrees (30°) are designated by line L₇; experimental results for a rotor angle of attack (α_{R}) of twenty degrees (20°) are designated by line L₈; experimental results for a rotor angle of attack (α_{R}) of ten degrees (10°) are designated by line L₉; and experimental results for a rotor angle of attack (α_{R}) of zero degrees (0°) are designated by line L₁₀. For lucidity reasons, the designations and accompanying lead lines for L₁-L₁₀ are absent in FIGS. 6B and 6C.

In a similar fashion, and for comparison purposes in the graphs of FIGS. 6A-6C, thrust force estimations and predictions of the first physics-based mathematical model for a rotor angle of attack (α_{R}) of ninety degrees (90°) are designated by x-marks M₁; estimations and predictions for a rotor angle of attack (α_{R}) of eighty degrees (80°) are designated by x-marks M₂; estimations and predictions for a rotor angle of attack (α_{R}) of seventy degrees (70°) are designated by x-marks M₃; estimations and predictions for a rotor angle of attack (α_{R}) of sixty degrees (60°) are designated by x-marks M₄; estimations and predictions for a rotor angle of attack (α_{R}) of fifty degrees (50°) are designated by x-marks M₅; estimations and predictions for a rotor angle of attack (α_{R}) of forty degrees (40°) are designated by x-marks M₆; estimations and predictions for a rotor angle of attack (α_{R}) of thirty degrees (30°) are designated by x-marks M₇; estimations and predictions for a rotor angle of attack (α_{R}) of twenty degrees (20°) are designated by x-marks M₈; estimations and predictions for a rotor angle of attack (α_{R}) of ten degrees (10°) are designated by x-marks M₉; and estimations and predictions for a rotor angle of attack (α_{R}) of zero degrees (0°) are designated by x-marks M₁₀. For lucidity reasons, the designations and accompanying lead lines for M₁-M₁₀ are absent in FIGS. 6B and 6C. In this example experiment, the thrust force estimations and predictions of the first physics-based mathematical model were executed onboard a quadrotor autonomous UAV similar to the autonomous UAV 10 and via a feedforward flight control similar to that described herein. The C programming language was utilized, as well as optimized compilers and specific libraries suited for Cortex-A8 processors.

Overall, and in general, the thrust force estimations and predictions of the first physics-based mathematical model were observed to exhibit suitable accordance with the experimental results for wind tunnel speeds of V_{∞}=5 m/s, V_{∞}=10 m/s, and V_{∞}=15 m/s, and for rotor angles of attack (α_{R}) of 90°, 80°, 70°, 60°, 50°, 40°, 30°, 20°, 10°, and 0°. Moreover, as evidenced by the graphs of FIGS. 6A-6C, the estimations and predictions and experimental results observed at wind tunnel speeds of V_{∞}=5 m/s and V_{∞}=10 m/s and at increased rotor angles of attack (α_{R}) demonstrate particular accordance with each other.

As previously described, the second physics-based mathematical model yields estimated predictions of the rotor drag force (F_{D}) acting on the autonomous UAV 10 during flight. The rotor drag force (F_{D}) is often referred to as drag represented in the body and frame 22 of the autonomous UAV 10, with reference again to FIG. 1. For a single and individual rotor 12, the associated drag force consists of blade profile drag and induced drag. It has been found to be cumbersome to quantify drag force accurately using geometry and flight parameters in view of the relative complex nature of the problem. Aerodynamic models to represent drag force are hence uncommon, and past models are often formulated as a function of thrust. The second physics-based mathematical model, in contrast, is a semi-empirical model for the rotor drag force (F_{D}) that was developed using experimental data, per this embodiment. Using the same example experiment setup described with reference to FIG. 5, rotor drag force (F_{D}) can be obtained with equations 4 presented above.

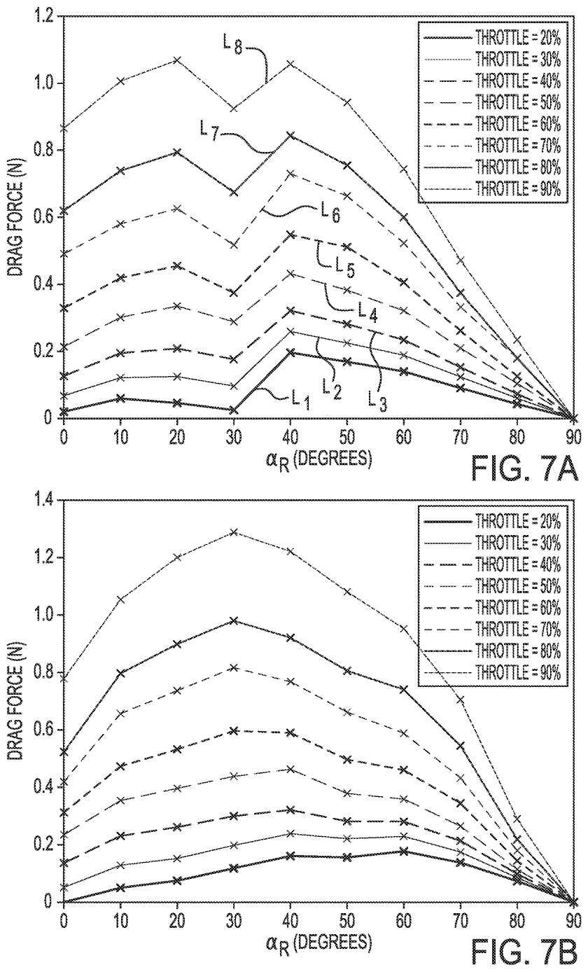

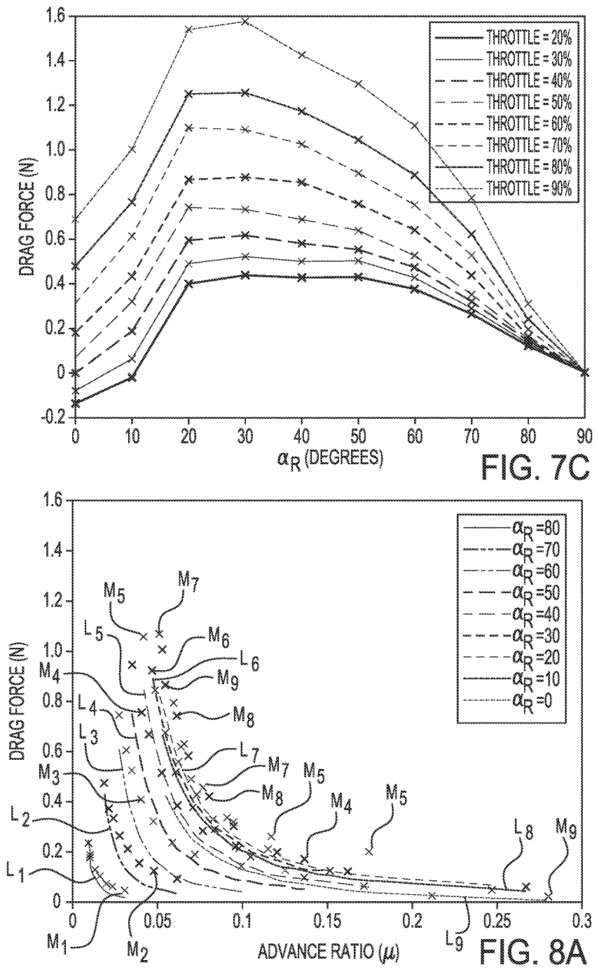

FIGS. 7A-7C present results in graphical form of example experiments conducted with the setup of FIG. 5; still, skilled artisans should appreciate that other experiments may yield varying results. In the graphs, rotor drag force (F_{D}; Newtons, N) is plotted on a y-axis and rotor angle of attack (α_{R}; degrees) is plotted on an x-axis. FIG. 7A exhibits experimental results for wind tunnel speed of V_{∞}=5 m/s; FIG. 7B exhibits experimental results for wind tunnel speed of V_{∞}=10 m/s; and FIG. 7C exhibits experimental results for wind tunnel speed of V_{∞}=15 m/s. In the graphs of FIGS. 7A-7C, experimental results for a throttle value of 20% are designated by line L₁; experimental results for a throttle value of 30% are designated by line L₂; experimental results for a throttle value of 40% are designated by line L₃; experimental results for a throttle value of 50% are designated by line L₄; experimental results for a throttle value of 60% are designated by line L₅; experimental results for a throttle value of 70% are designated by line L₁; experimental results for a throttle value of 80% are designated by line L₇; and experimental results for a throttle value of 90% are designated by line L₈. For lucidity reasons, the designations and accompanying lead lines for L₁-L₈ are absent in FIGS. 7B and 7C. The results of FIGS. 7A-7C demonstrate that rotor drag force (F_{D}) increases as the wind tunnel speed (V_{∞}) increases. Other observations from the results of FIGS. 7A-7C include: as the throttle value increases, and the attendant RPM of the propeller 30 increases, the rotor drag force (F_{D}) increases; the rotor drag force (F_{D}) exhibits maximum value when the rotor angle of attack (α_{R}) is approximately between twenty and thirty degrees (20°<α_{R}<30°); the rotor drag force (F_{D}) exhibits an increase in value from zero to thirty degrees (0°≤α_{R}≤30°), and then the rotor drag force (F_{D}) exhibits a decrease in value from forty to ninety degrees (40°≤α_{R}≤90°) which is indicative of a non-linear behavior of drag in body frame versus rotor angle of attack.

The second physics-based mathematical model, in general, uses rotor drag force measurements (e.g., those of the example experiments of FIGS. 7A-7C) and an optimization procedure in order to yield estimated predictions of the rotor drag force (F_{D}) acting on the subject autonomous UAV amid flight. The second physics-based mathematical model was designed to represent induced and viscous drag, as well as blade profile drag (C_{d0}), while correlating the experimental data. The second physics-based mathematical model relates drag force coefficient

$$( {C}_{FD} = {F}_{D} / ρ π {R}^{2} {V}_{tip}^{2} ; where {V}_{tip} is rotor tip velocity , m / s )$$

to the thrust coefficient (C_{T}), which can be obtained using the first physics-based mathematical model of equation 3, and to other non-dimensional flight parameters. The second physics-based mathematical model is presented in equation 5 below:

$${C}_{FD} = [ ( {a}_{1} {C}_{T} ( sin ( {α}_{R} ) + {b}_{1} ) ) {Rev}_{∞}^{0.4} + {c}_{1} σ {c}_{do} ( {μ}^{2} + {λ}^{2} ) ( sin ( {α}_{R} ) + {d}_{1} ) ] cos {α}_{R}$$

where the Reynolds number (Re; V_{∞}c/v) is based on the free stream, and rotor diameter is Rev_{∞}=2RV_{∞}/v (where v is wind velocity represented in the body and frame 22, m/s). Further, blade solidity is σ=0.1083, blade profile drag is c_{d0}=0.008. Coefficients a, b, c, and d can be obtained using curve fitting and an optimization procedure, and, per an example, the coefficients are a₁=27.87e−04, b₁=75.37e−4, c₁=178.8960, d₁=−0.1463. It is pertinent to note that the second physics-based mathematical model of equation 5, with an additional parasite drag Dₚ (see equation 19 below), can be employed to represent a quad-copter drag force set forth below in equations 13-15.

Further, the second physics-based mathematical model exhibits universality for rotors 12 that are smaller in size, and is not specific to the rotor 12 of the example experiment set forth above. Geometric properties of the rotor 12 manifest themselves in the thrust coefficient (C_{T}). The experimental data incorporate extensive rotor drag force measurements over various incoming wind velocities (i.e., wind tunnel speeds), rotor angles of attack (α_{R}), and RPM conditions.

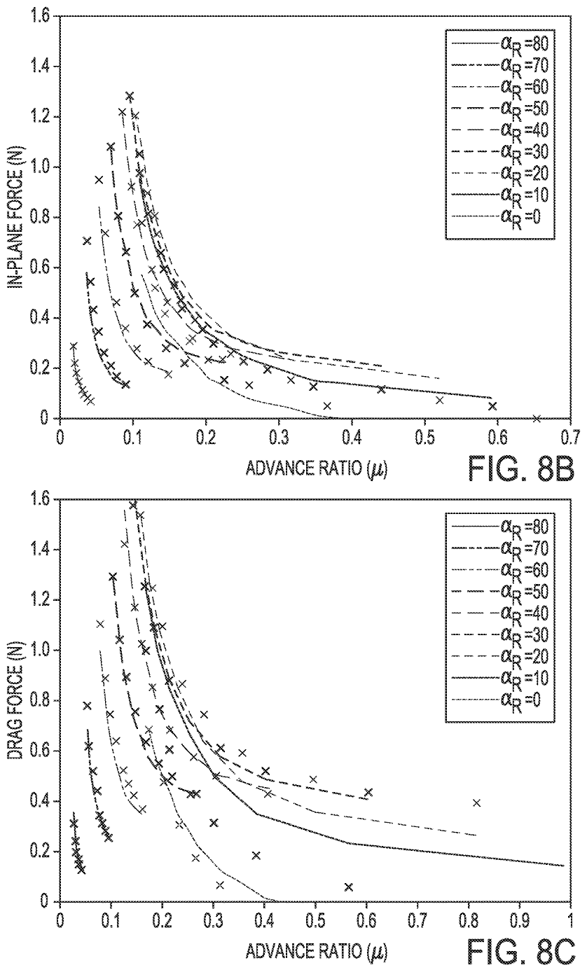

FIGS. 8A-8C present results in graphical form of example experiments conducted with the setup of FIG. 5; still, skilled artisans should appreciate that other experiments may yield varying results. In the graphs, rotor drag force (F_{D}; Newtons, N) is plotted on a y-axis and advance ratio (μ) is plotted on an x-axis. FIG. 8A exhibits experimental results for wind tunnel speed of V_{∞}=5 m/s; FIG. 8B exhibits experimental results for wind tunnel speed of V_{∞}=10 m/s; and FIG. 8C exhibits experimental results for wind tunnel speed of V_{∞}=15 m/s. Rotor drag force estimations and predictions of the second physics-based mathematical model are indicated generally in FIGS. 8A-8C by “x” marks. Furthermore, in the graphs of FIGS. 8A-8C, experimental results for a rotor angle of attack (α_{R}) of eighty degrees (80°) are designated by line L₁; experimental results for a rotor angle of attack (α_{R}) of seventy degrees (70°) are designated by line L₂; experimental results for a rotor angle of attack (α_{R}) of sixty degrees (60°) are designated by line L₃; experimental results for a rotor angle of attack (α_{R}) of fifty degrees (50°) are designated by line L₄; experimental results for a rotor angle of attack (α_{R}) of forty degrees (40°) are designated by line L₅; experimental results for a rotor angle of attack (α_{R}) of thirty degrees (30°) are designated by line L₆; experimental results for a rotor angle of attack (α_{R}) of twenty degrees (20°) are designated by line L₇; experimental results for a rotor angle of attack (α_{R}) of ten degrees (10°) are designated by line L₈; and experimental results for a rotor angle of attack (α_{R}) of zero degrees (0°) are designated by line L₉. For lucidity reasons, the designations and accompanying lead lines for L₁-L₉ are absent in FIGS. 8B and 8C.

In a similar fashion, and for comparison purposes in the graphs of FIGS. 8A-8C, rotor drag force estimations and predictions of the second physics-based mathematical model for a rotor angle of attack (α_{R}) of eighty degrees (80°) are designated by x-marks M₁; estimations and predictions for a rotor angle of attack (α_{R}) of seventy degrees (70°) are designated by x-marks M₂; estimations and predictions for a rotor angle of attack (α_{R}) of sixty degrees (60°) are designated by x-marks M₃; estimations and predictions for a rotor angle of attack (α_{R}) of fifty degrees (50°) are designated by x-marks M₄; estimations and predictions for a rotor angle of attack (α_{R}) of forty degrees (40°) are designated by x-marks M₅; estimations and predictions for a rotor angle of attack (α_{R}) of thirty degrees (30°) are designated by x-marks M₆; estimations and predictions for a rotor angle of attack (α_{R}) of twenty degrees (20°) are designated by x-marks M₇; estimations and predictions for a rotor angle of attack (α_{R}) of ten degrees (10°) are designated by x-marks M₈; and estimations and predictions for a rotor angle of attack (α_{R}) of zero degrees (0°) are designated by x-marks M₉. For lucidity reasons, the designations and accompanying lead lines for M₁-M₉ are absent in FIGS. 8B and 8C. Overall, and in general, the rotor drag force estimations and predictions of the second physics-based mathematical model were observed to exhibit suitable accordance with the experimental results for wind tunnel speeds of V_{∞}=5 m/s, V_{∞}=10 m/s, and V_{∞}=15 m/s, and for rotor angles of attack (α_{R}) of 80°, 70°, 60°, 50°, 40°, 30°, 20°, 10°, and 0°, especially in view of the often-complex nature of rotor drag force. The second physics-based mathematical model is observed to represent the non-linearity of rotor drag force with suitable accordance.

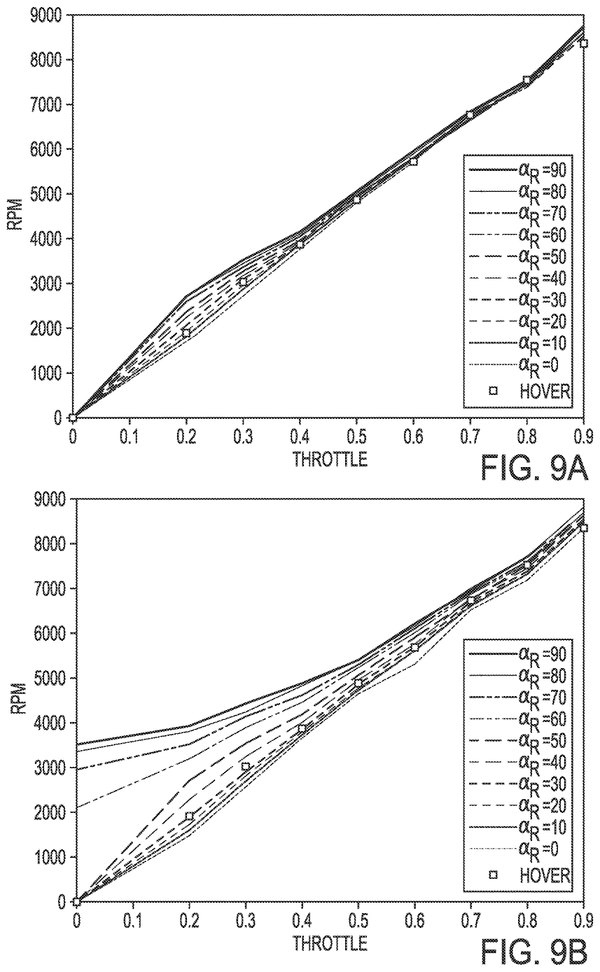

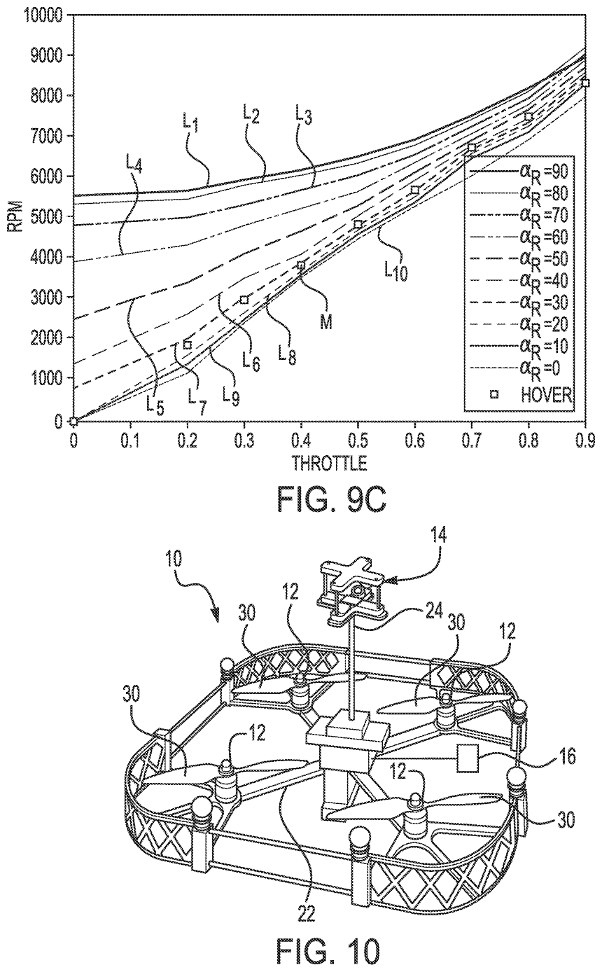

The relationship between RPM of the rotors 12 and the corresponding throttle input data has often been obtained when the accompanying autonomous UAV 10 is in a hover flight condition and with the use of a dynamometer. But in practice it has been found that the incoming wind flow and rotor angles of attack (α_{R}) can alter the relationship between RPM of the rotors 12 and the corresponding throttle input data due to changes in loading experienced and exerted on the blades 26 of the rotors 12. In view of this appreciation, the experimental results and data of FIGS. 8A-8C were utilized in order to formulate a relationship between RPM measurements of the rotors 12 and throttle input data. Revolutions per minute (RPM) measurements of the rotors 12 were taken by the optic sensor 36 in the setup of FIG. 5. For incoming wind velocities and wind tunnel speeds of V_{∞}=5 m/s, 10 m/s, and 15 m/s, the relationship between RPM measurements of the rotors 12 and throttle input data and level is presented in FIGS. 9A-9C for various rotor angles of attack (α_{R}).

FIGS. 9A-9C present results in graphical form of example experiments conducted with the setup of FIG. 5; still, skilled artisans should appreciate that other experiments may yield varying results. In the graphs, revolutions per minute measurements of the rotors 12 (RPM) is plotted on a y-axis and throttle input is plotted on an x-axis. FIG. 9A exhibits experimental results for wind tunnel speed of V_{∞}=5 m/s; FIG. 9B exhibits experimental results for wind tunnel speed of V_{∞}=10 m/s; and FIG. 9C exhibits experimental results for wind tunnel speed of V_{∞}=15 m/s. In the graphs of FIGS. 9A-9C, experimental results for a rotor angle of attack (α_{R}) of ninety degrees (90°) are designated by line L₁; experimental results for a rotor angle of attack (α_{R}) of eighty degrees (80°) are designated by line L₂; experimental results for a rotor angle of attack (α_{R}) of seventy degrees (70°) are designated by line L₃; experimental results for a rotor angle of attack (α_{R}) of sixty degrees (60°) are designated by line L₄; experimental results for a rotor angle of attack (α_{R}) of fifty degrees (50°) are designated by line L₅; experimental results for a rotor angle of attack (α_{R}) of forty degrees (40°) are designated by line L₆; experimental results for a rotor angle of attack (α_{R}) of thirty degrees (30°) are designated by line L₇; experimental results for a rotor angle of attack (α_{R}) of twenty degrees (20°) are designated by line L₈; experimental results for a rotor angle of attack (α_{R}) of ten degrees (10°) are designated by line L₉; and experimental results for a rotor angle of attack (α_{R}) of zero degrees (0°) are designated by line L₁₀. For lucidity reasons, the designations and accompanying lead lines for L₁-L₁₀ are absent in FIGS. 9A and 9B. Furthermore, and for comparison purposes in the graphs of FIGS. 9A-9C, experimental results for a hover flight condition are designated by square marks M. Observations from the results of FIGS. 9A-9C include: the greater the incoming wind velocities and wind tunnel speeds and rotor angles of attack (α_{R}) are, the greater the experimental results deviate from the corresponding hover flight condition values (e.g., see line L₁ for V_{∞}=15 m/s in FIG. 9C); and for lower speed flights of the autonomous UAV 10 (e.g., V_{∞}<5 m/s), the hover flight condition is suitable for use for all rotor angles of attack (i.e., α_{R} of 0° to 90°).

Additional experiments were conducted in order to enable utilization of the first and second physics-based mathematical models onboard an autonomous UAV. As previously set forth, in this embodiment the first and second physics-based mathematical models are implemented in the flight software of the controller 16. With reference again to FIG. 10, the autonomous UAV 10 has a quadrotor and X-configuration form. An X-configuration, in general, often exhibits enhanced maneuverability compared to a +-configuration given that a pair of X-configuration rotors 12 are utilized for rolling and pitching moments. Still, the +-configuration form can be employed for the autonomous UAV 10 in other embodiments. Sensors, such as the optic sensor 36, for measuring RPM of the rotors' electric motors were employed with the autonomous UAV 10, as well as sensors, such as the wind sensor 14, for measuring the incident wind condition. Flight control software from the Strawson Robot Control Library (http://strawsondesign.com/docs/librobotcontrol/index.html) was adapted for the purposes of these experiments. Controllers for attitude, altitude, and position control of the autonomous UAV 10 were developed.

In these additional experiments, the autonomous UAV 10 was powered by a 3S Lipo battery and its propellers 30 had a diameter of eight inches (8 in.), as previously described. Four 8-inch propellers 30, in particular, were found to provide suitable lift for the autonomous UAV 10. It can be observed here that the first physics-based mathematical model can be used amid the design process in order to determine a suitable blade shape and size. Further, the onboard computer of the autonomous UAV 10 was the Linux-based computer known as the BeagleBone® Blue computer that had an AM335x 1 GHz ARM® Cortex A8 processor. The first physics-based mathematical model was executed on this onboard computer. The first physics-based mathematical model was implemented in the C programming language and compiled using certain Cortex-A CPU libraries in order to increase performance. The first physics-based mathematical model was executed on this onboard computer. The autonomous UAV 10 of these experiments, and as presented in FIG. 10, had an overall approximate weight of 1,080 grams, and an approximate size of 40 centimeters in cross-width, 40 centimeters in cross-length, and 6 centimeters in height (i.e., 40 cm×40 cm×6 cm).

A first controller was employed in the autonomous UAV 10 for inner-loop attitude control. The first controller, per the embodiment of these experiments, was a proportional-integral-derivative (PID) controller; still, more sophisticated controllers and controllers of other types could be used in other embodiments. The first controller effects feedback control. The input to the first controller is an error (e(t)) that is defined as the desired state minus the current state; e(t)=x_{d}(t)−x(t) as presented in equation 6 below.

$$u ( t ) = {K}_{P} e ( t ) - {K}_{i} {\int }_{0}^{t} e ( τ ) d τ + {K}_{d} \frac{d e ( t )}{dt}$$

The output (u(t)) serves as the control that drives the system towards the desired setpoints. In attitude control, the desired Euler angles may be set by the outer-loop position controller (described below). Further, in the embodiment of these experiments, the current Euler angles were measured using an onboard gyroscope of the BeagleBone® Blue computer.

A second controller was employed in the autonomous UAV 10 for outer-loop position control. The second controller, per the embodiment of these experiments, was a proportional-derivative (PD) controller; still, more sophisticated controllers and controllers of other types could be used in other embodiments. The second controller effects feedback control. The second controller serves to track an intended and target fight trajectory of the autonomous UAV 10. At every time step, the difference between a current and desired position was found, (i.e., errₓ, err_{y}, and err_{z}), and roll and pitch setpoint angles were θₛₚ=PD(−errₓ), φₛₚ=PD(err_{y}). The setpoint pitch and roll angles were then transmitted to the first controller in order to command the autonomous UAV 10 to follow the target trajectory.

A third controller was employed in the autonomous UAV 10 for altitude control. The third controller, per the embodiment of these experiments, was a proportional-derivative (PD) controller; still, more sophisticated controllers and controllers of other types could be used in other embodiments. The third controller effects feedback control. In a similar manner as the second controller, for the third controller err_{z} was determined as a difference between current and target heights and was input to the third controller. Equation 7, presented below, constitutes a design of the third controller:

$${U}_{Z} = {Throttle}_{hover} + \frac{PD ( {err}_{Z} )}{cos ϕcos θ}$$

where U(Z) is the control output, and Throttleₕₒᵥₑᵣ is the approximate throttle for hovering and is constant. Throttleₕₒᵥₑᵣ was set to equal −0.6 for the autonomous UAV 10 per the embodiment of these experiments. It is observed that altitude control gains may be updated based on current battery voltage in the autonomous UAV 10.

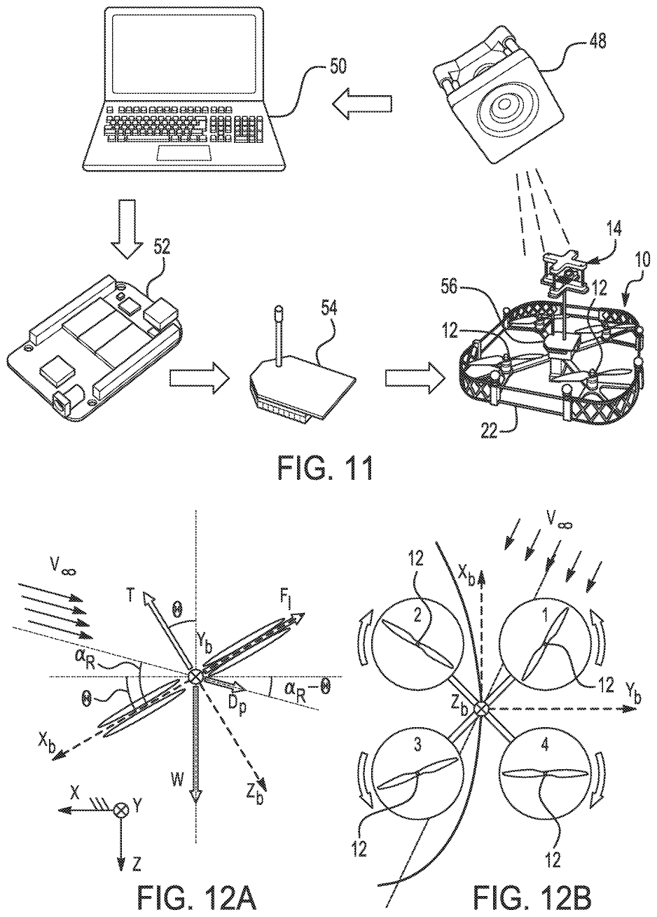

FIG. 11 presents an embodiment of a communication and information circulation setup for position control of the autonomous UAV 10 in these experiments. The setup constitutes a motion capture system and ground station according to this embodiment. Still, in other embodiments the setup could include more, less, and/or different components than presented here. In the embodiment of FIG. 11, the setup included a motion capture camera 48, a first computer 50, a second computer 52, a transmitter 54, and a receiver 56. The motion capture camera 48 was provided by NaturalPoint Inc. DBA OptiTrack (www.optitrack.com), and was used to estimate the position of the autonomous UAV 10 in real-time. Associated position information was thereby obtained. The motion capture camera 48 could provide the position information and Euler angles of the autonomous UAV 10. The on-board gyroscope of the BeagleBone® Blue computer, on the other hand, was used to estimate current roll, pitch, and yaw information of the autonomous UAV 10. In the experiments, the position information was initially transmitted to the first computer 50. The first computer 50 was a laptop that was installed with the optical motion capture software under the product name Motive provided by NaturalPoint Inc. DBA OptiTrack. The position information was received by the Motive software. The position information was then transmitted to, and received by, the second computer 52. In the embodiment here, the second computer 52 was the Linux-based computer known as the BeagleBone® Black computer that had an AM335x 1 GHz ARM® Cortex A8 processor. From there, the position information was transmitted to, and received by, the transmitter 54. The transmission to the transmitter 54 was via a serial port. In this embodiment, the transmitter 54 was a product named XBee-Pro provided by Digi International Inc. (www.digi.com). Further, the receiver 56 was carried onboard the autonomous UAV 10. The receiver 56 received the position information from the transmitter 54. In this embodiment, the receiver 56 was an XBee receiver provided by Digi International Inc.

FIGS. 12A and 12B present a schematic demonstration of certain forces applied to the autonomous UAV 10 when subject to a strong crosswind on an arbitrary path. While contributions to drag on the body and frame 22 can come from numerous sources, they can be decomposed to the rotor drag force (F_{D}) and parasite drag D_{P} at a system level. A full balance of forces acting on the autonomous UAV 10 is illustrated in FIGS. 12A and 12B. In the body and frame 22, the balance of forces can be represented in equations 8, 9, and 10 below, respectively.

$$\sum {F}_{xb} = ( {F}_{D} + {D}_{P} cos {α}_{R} ) \frac{{v}_{x}}{\sqrt{{v}_{x}^{2} + {v}_{y}^{2}}} - W sin θ , \\ \sum {F}_{yb} = ( {F}_{D} + {D}_{P} cos {α}_{R} ) \frac{{v}_{y}}{\sqrt{{v}_{x}^{2} + {v}_{y}^{2}}} - W cos θsin ϕ , \\ \sum {F}_{zb} = {D}_{P} sin {α}_{R} - T + W cos θco s ϕ .$$

where vₓ, v_{y}, and v_{z} are the relative wind velocities (m/s) in the x, y, and z directions represented in the body and frame 22.

The matrix known as the direction cosine matrix (DCM) is a rotation matrix that transfers a vector from the body and frame 22 to the inertial frame and is assumed in the order of yaw-pitch-roll, as presented in equation 11 below:

$$DCM = [ \begin{matrix}cos θcos ψ & cos ψ sin θsin ϕ - sin ψ cos ϕ & cos ψ sin θcos ϕ + sin ψ sin ϕ \\ cos θsin ψ & sin ψ sin θsin ϕ + cos ψ cos ϕ & sin ψ sin θcos ϕ - cos ψ sin ϕ \\ - sin θ & sin ϕ cos θ & cos ϕ cos θ\end{matrix} ]$$

The balance of forces acting on the autonomous UAV 10 in the body and frame 22 can be transferred to the inertial frame. Yaw motion can be an independent variable in attitude control design. In the embodiment here, the reference yaw angle is kept at a zero value for simplicity of derivation of the analytical solution. Accordingly, the inertial forces can be obtained according to equation 12, presented below:

$$[ \begin{matrix}\sum {F}_{X} \\ \sum {F}_{Y} \\ \sum {F}_{Z}\end{matrix} ] = [ \begin{matrix}cos θ & sin θ sin ϕ & sin θ cos ϕ \\ 0 & cos ϕ & - sin ϕ \\ - sin θ & sin ϕ cos θ & cos ϕ cos θ\end{matrix} ] [ \begin{matrix}\sum {F}_{xb} \\ \sum {F}_{yb} \\ \sum {F}_{zb}\end{matrix} ]$$

Therefore, the net forces in the inertial frame can be obtained by equations 13, 14, and 15 below, respectively:

$$\sum {F}_{X} = \frac{{F}_{D} + {D}_{p} cos {α}_{R}}{\sqrt{{v}_{x}^{2} + {v}_{y}^{2}}} ( {v}_{x} cos θ + {v}_{y} sin θsin ϕ ) + sin θ cos ϕ ( {D}_{P} sin {α}_{R} - T ) , \\ \sum {F}_{Y} = \frac{{F}_{D} + {D}_{p} cos {α}_{R}}{\sqrt{{v}_{x}^{2} + {v}_{y}^{2}}} ( {v}_{y} cos ϕ ) - sin ϕ ( {D}_{P} sin {α}_{R} - T ) , \sum {F}_{Z} = \frac{{F}_{D} + {D}_{p} cos {α}_{R}}{\sqrt{{v}_{x}^{2} + {v}_{y}^{2}}} ( - {v}_{x} sin θ + {v}_{y} sin ϕcos θ ) + cos θ cos ϕ ( {D}_{P} sin {α}_{R} - T ) + W .$$

In the equilibrium condition, the net forces in all three directions in the inertial frame are zero. Equations 13, 14, and 15 can be set to zero in order to find the equilibrium pitch and roll angles (yaw was set to zero). By multiplying equation 13 by cos θ and adding it to equation 15 multiplied by −sin θ, the pitch angle can directly be obtained by equation 16, presented below:

$${θ}_{ref} = {sin}^{- 1} \frac{\frac{{F}_{D} + {D}_{P} cos {α}_{R}}{\sqrt{{v}_{x}^{2} + {v}_{y}^{2}}} {v}_{x}}{W}$$

Using mathematical manipulations, a closed-form solution can be derived. The thrust force and roll angle (φ) can be determined by equations 17 and 18 below, respectively:

$${T}_{ref} = {D}_{P} sin {α}_{R} + \sqrt{{W}^{2} - {( {F}_{D} + {D}_{P} cos {α}_{R} )}^{2}} , \\ {ϕ}_{ref} = {tan}^{- 1} \frac{\frac{{F}_{D} + {D}_{P} cos {α}_{R}}{\sqrt{{v}_{x}^{2} + {v}_{y}^{2}}} ( {v}_{y} )}{- \sqrt{{W}^{2} - {( {F}_{D} + {D}_{P} cos {α}_{R} )}^{2}}}$$

It is noted that equation 17 may be solved prior to solving equations 16 and 18 since there is a thrust force (T) term embedded in the rotor drag force (F_{D}). Accordingly, an optimization is employed to solve equation 17 in order to find Tar, and subsequently, equations 16 and 18 can be solved for finding θ_{ref} and φ_{ref}. The rotor drag force (F_{D}) is computed using second physics-based mathematical model of equation 5. Further, a simpler model for parasite drag (Dₚ) can be formulated—assuming the body and frame 22 of the autonomous UAV 10 is a flat strip—according to equation 19, presented below:

$${D}_{P} = \frac{1}{2} ρ ( {S}_{q} ) ( {ν}_{x}^{2} + {v}_{y}^{2} + {v}_{z}^{2} )$$

where S_{q}=0.4*0.06 m² is an approximate to the front area of the quadrotor autonomous UAV 10. In equation 19, a rough estimate of one (1) for drag coefficient was incorporated and deemed to be appropriate in view of the shape of the quadrotor autonomous UAV 10.

It has been found, according to an embodiment, that a consequential accommodation in employing use of feedforward flight control is the removal of extraneous motion of the quadrotor autonomous UAV 10 from the wind measurements. Assuming that wind velocity is substantially horizontal in direction in the inertial frame, the z-velocity (here, it is denoted w_{ff}) in the body and frame 22 (i.e., the wind sensor 14 frame) can be determined using the directional cosine matrix (DCM). Indeed, u_{ff}, v_{ff}, and w_{ff} in equation 20 below represent the “corrected” relative wind velocities experienced by the quadrotor autonomous UAV 10 represented in the body and frame 22. Accordingly, the velocity input to the controller 16 is represented according to equation 20, presented below:

u_{ff}=vₓ+U−Uₛₚ; v_{ff}=v_{y}+V−Vₛₚ; w_{ff}=u_{ff} tan θ cos φ−v_{ff} tan φ

where U and V are the horizontal velocities of the quadrotor autonomous UAV 10 obtained by taking derivatives of the positions recorded by the motion capture system of FIG. 11. Further, Uₛₚ and Vₛₚ are the setpoint horizontal velocities assigned by the intended and target fight trajectory of the autonomous UAV 10. Accordingly, u_{ff}, v_{ff}, and w_{ff} can replace vₓ, v_{y}, and v_{z} respectively in equations 16, 17, and 18 and Dₚ. As previously set forth, the reference roll and pitch angles (φ_{ref} and θ_{ref}) are the physical steady solutions to quadrotor autonomous UAV attitude subject to a crosswind wind. The reference roll and pitch angles are directly added to the inner-loop attitude proportional-integral-derivative (PID) control outputs. The reference thrust force (T_{ref}), per an embodiment, can be used in altitude control to replace the assumed constant hover throttle. That is, T_{ref} can be initially mapped to a rotor RPM using the first physics-based mathematical model. Then, the rotor RPM can be converted to throttle input using the relationship between RPM measurements of the rotors 12 and throttle input data and level presented in FIGS. 9A-9C.

Flight testing of the autonomous UAV 10 was carried out in order to assess the integrability, capability, and usability of the first and second physics-based mathematical models and of feedforward flight control. The flight testing and experimental setup is depicted and demonstrated in FIG. 14. Flight tests were conducted in an indoor testing facility 58 equipped with a motion capture system having a multitude of cameras 60, seven in total. The cameras 60 were positioned around the intended and target flight trajectory for effective motion tracking of the autonomous UAV 10. A ground station 62 provided any testing personnel an opportunity to visually observe the autonomous UAV 10 amid testing. An industrial axial fan 64 was utilized for the testing in order to simulate extreme and severe environmental conditions, such as sudden and strong crosswinds and wind gusts in the indoor testing facility 58. The industrial axial fan 64 had fan blades with a diameter of three feet (3 ft; ≈0.91 m). An intended and target flight trajectory for the testing is denoted in FIG. 14 by broken line 66, and in this experiment was a circular flight path. Flight tests were performed for two modes of use of the autonomous UAV 10: i) an autonomous mode of use, and ii) a sensed autonomous mode of use. In the autonomous mode of use, only the feedback flight control was used for flight trajectory control, and feedforward flight control was not used. In the sensed autonomous mode of use, in contrast, both feedforward flight control and feedback flight control were used for flight trajectory control. Results for flying in extreme and severe environmental conditions (i.e., with the industrial axial fan 64 set to ON) were compared to flying without the extreme and severe environmental conditions (i.e., with the industrial axial fan 64 set to OFF). Skilled artisan should appreciate that other flight tests and/or other testing setups may yield results that vary compared to those presented herein.

Furthermore, for both of the autonomous and sensed autonomous modes of use, the same PD gains for feedback control were implemented. Multiple autonomous and manual flight tests were conducted in order to tune the PD gains. The PD gains were primarily tuned for the autonomous mode of use. In other words, in the flight tests of these examples, the performance of the feedforward flight control in the sensed autonomous mode of use was tested as a supplement to an already tuned feedback control system in the autonomous mode of use. Per these examples of the flight tests, the tuned PD gains for low level control are presented in table 2:

TABLE 2

| | Kₚ | Kᵢ | K_{d} |
|---|---|---|---|
| Roll | 0.5 | 0.0 | 0.25 |
| Pitch | 0.5 | 0.0 | 0.25 |
| Yaw | 3.0 | 0.0 | 1 |

Also, per these flight tests examples, the tuned PD gains for X- and Y-position controls are presented in table 3:

TABLE 3

| Kₚ | Kᵢ | K_{d} |
|---|---|---|
| 0.5 | 0.0 | 0.2 |

Further, per these flight tests examples, the tuned PD gains for altitude control are presented in table 4:

TABLE 4

| Kₚ | Kᵢ | K_{d} |
|---|---|---|
| 0.35 | 0.0 | 0.15 |

In these example flight tests and testing setup, when the industrial axial fan 64 was initially set to ON, a strong crosswind roughly impinged the quadrotor autonomous UAV 10 and impinged the wind sensor 14, with the same intensity during the flight testing in view of the large diameter of the industrial axial fan 64 used in these example flight tests. The wind flow around the quadrotor autonomous UAV 10 was highly turbulent, and the turbulent crosswind had a magnitude of approximately 6 m/s, as measured by the wind sensor 14. It is noted that the quadrotor autonomous UAV 10 was in a tailwind condition, in certain instances, given the wind blowing towards the direction of flight amid the testing. As a general aside for these example flight tests and the accompanying description, values that are referred to as a target or a setpoint (e.g., “sp”) are the desired state variables and conditions that the associated trajectory planner generates; and values that are referred to as reference (e.g., “ref”) are those provided by the feedforward flight controller 16.

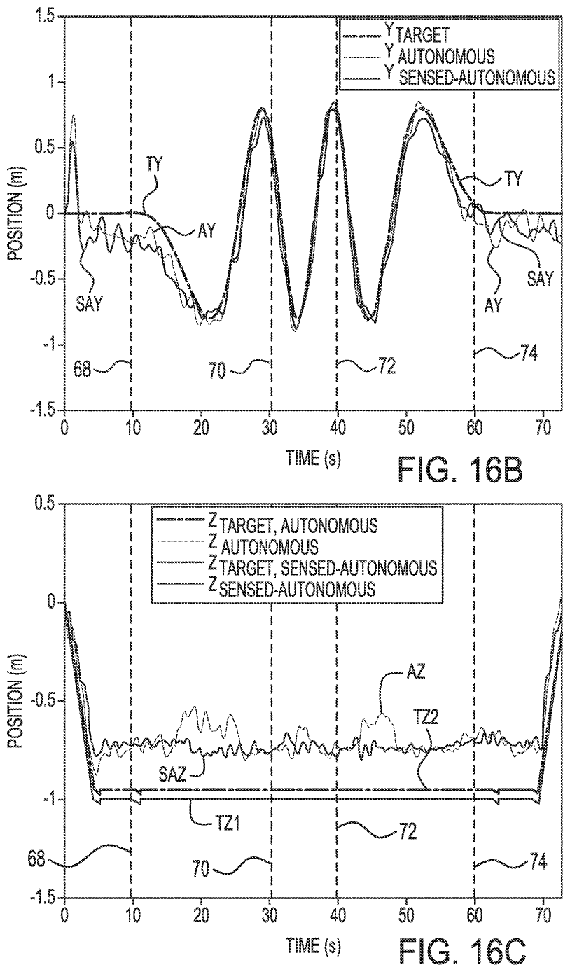

The example flight tests and testing setup was designed with certain trajectory specifications for the quadrotor autonomous UAV 10. The circular flight path 66, or circular trajectory, had a diameter of Dₜ=1.5 meters (m). The overall trajectory was made-up of multiple segments. A first segment involved take-off from the ground-floor to an altitude of approximately hₛₚ=1.1 meters (m) with a constant speed over a time of 4 seconds (s). A second segment involved hovering the quadrotor autonomous UAV 10 for 1 second (s). A third segment involved moving the quadrotor autonomous UAV 10 from the center of the circular flight path 66 to its perimeter with a constant speed over a time of 0.167 seconds (s). A fourth segment again involved hovering the quadrotor autonomous UAV 10 for 1 second (s). A fifth segment involved accelerating the quadrotor autonomous UAV 10 in a linear manner to a cruise speed of Vₜ=0.5 m/s in a direction that is clockwise over a single full-circle span of the circular flight path 66. A sixth segment involved flying the quadrotor autonomous UAV 10 with the maintained cruise speed of Vₜ=0.5 m/s in the clockwise direction over another single full-circle span of the circular flight path 66. And a seventh segment involved the reversal of the fifth through first segments, namely: decelerating the quadrotor autonomous UAV 10 in a linear manner from the cruise speed of Vₜ=0.5 m/s in a direction that is counterclockwise over a single full-circle span of the circular flight path 66, halting movement of the quadrotor autonomous UAV 10, hovering the quadrotor autonomous UAV 10 for 1 second (s), moving the quadrotor autonomous UAV 10 back to the center of the circular flight path 66 from the perimeter with a constant speed over a time of 0.167 seconds (s), hovering the quadrotor autonomous UAV 10 for 1 second (s) at the center, and landing the quadrotor autonomous UAV 10 to the ground-floor from the altitude of approximately hₛₚ=1.1 meters (m). Accordingly, in total, the overall trajectory involved three full-circle spans of the circular flight path 66 at the setpoint altitude of approximately hₛₚ=1.1 meters (m). In the graphs of FIGS. 16A-16C, described in greater detail below, these three full-circle spans of the circular flight path 66 are demarcated by vertical broken-lines 68, 70, 72, and 74. The first of the full-circle spans occurs between lines 68 and 70, the second of the full-circle spans occurs between lines 70 and 72, and the third of the full-circle spans occurs between lines 72 and 74.

Moreover, in the example flight tests and testing setup, while the maximum sensor output rate of the example wind sensor 14 employed was nominally 40 Hz, the sensor output rate was set to 5 Hz in the example flight tests, corresponding to a sample averaged over a window of eight data points. Further, in order to smooth out the velocity inputs for feedforward flight control, a moving average was applied to equation 20 with a window size of three samples; it is noted that this action caused a time delay of about one second to the velocity input stream to the controller 16. Yet other observations and considerations made about the example flight tests and testing setup included: sensor output of the wind sensor 14 could be noisy, measurements by the wind sensor 14 in the X- and Y-directions exhibited sensitivity discrepancies, measurements by the wind sensor 14 in the Z-direction could be unsuitable, and local wind flow fields experienced at the wind sensor 14 and at the rotors 12 could differ in view of the distance between the components and despite the large diameter of the industrial axial fan 64. Still, additional observations and considerations are possible.

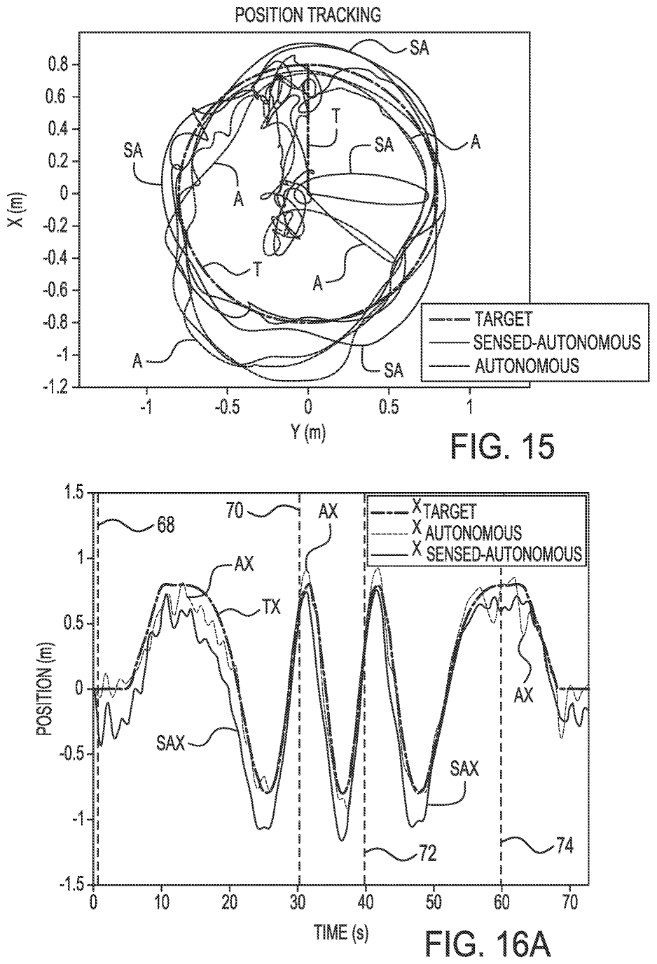

Initially, as part of the example flight tests and testing setup, the quadrotor autonomous UAV 10 was confirmed to execute and follow the intended and target flight trajectory of the circular flight path 66 when there was no extreme and severe environmental conditions (i.e., with the industrial axial fan 64 set to OFF). The air was observed as substantially still. This flight condition represented a base case in which only feedback flight control was used for flight trajectory control, and feedforward flight control was not used. In the base case, the intended and target flight trajectory of the quadrotor autonomous UAV 10 was tracked with acceptable accuracy over the majority of the circular flight path 66. The maximum discrepancy observed between the intended and target flight trajectory and the actual trajectory of the quadrotor autonomous UAV 10 was approximately 0.15 m and occurred when X=0 and Y was at a maximum (while the base case is not specifically plotted in the graph of FIG. 15, the graph can be referenced for position tracking and for gaining a sense of where this maximum discrepancy occurred).

With reference now to FIGS. 15 and 16A-16C, results of the flight tests are compared for the autonomous mode of use (i.e., feedback flight control) and the sensed autonomous mode of use (i.e., feedforward flight control and feedback flight control). FIG. 15 presents the experimental flight results in graphical form of position and trajectory tracking of the quadrotor autonomous UAV 10. X-position in meters is plotted on a y-axis, and Y-position in meters is plotted on an x-axis. In the graph of FIG. 15, the intended and target flight trajectory is designated by broken-line T; experimental flight results and trajectory of the sensed autonomous mode of use of the quadrotor autonomous UAV 10 is designated by solid-line SA; and experimental flight results and trajectory of the autonomous mode of use of the quadrotor autonomous UAV 10 is designated by broken-line A. Airflow from the industrial axial fan 64 is dominant for a Y-position of Y<0 in FIG. 15 (i.e., the leftside half circle of the circular flight path of the target flight trajectory T), as wind gusts blow from a positive X-position (+X) to a negative X-position (−X). Further, as is evident from FIG. 15, overall, the quadrotor autonomous UAV 10 maintained and followed the target flight trajectory T with greater accuracy in the sensed autonomous mode of use (SA) compared to the autonomous mode of use (A) at the leftside half circle where the quadrotor autonomous UAV 10 confronted more extreme and severe environmental wind conditions.

FIG. 16A presents experimental flight results in graphical form of X-position and trajectory tracking of the quadrotor autonomous UAV 10. X-position in meters is plotted on a y-axis, and time in seconds is plotted on an x-axis. In the graph of FIG. 16A, the intended and target flight trajectory with regards to X-position is designated by broken-line TX; experimental flight results and trajectory with regards to X-position of the sensed autonomous mode of use of the quadrotor autonomous UAV 10 is designated by solid-line SAX; and experimental flight results and trajectory with regards to X-position of the autonomous mode of use of the quadrotor autonomous UAV 10 is designated by broken-line AX. As is evident from FIG. 16A, on the whole, the quadrotor autonomous UAV 10 maintained and followed the target flight trajectory TX with greater accuracy in the sensed autonomous mode of use (SAX) compared to the autonomous mode of use (AX).

FIG. 16B presents experimental flight results in graphical form of Y-position and trajectory tracking of the quadrotor autonomous UAV 10. Y-position in meters is plotted on a y-axis, and time in seconds is plotted on an x-axis. In the graph of FIG. 16B, the intended and target flight trajectory with regards to Y-position is designated by broken-line TY; experimental flight results and trajectory with regards to Y-position of the sensed autonomous mode of use of the quadrotor autonomous UAV 10 is designated by solid-line SAY; and experimental flight results and trajectory with regards to Y-position of the autonomous mode of use of the quadrotor autonomous UAV 10 is designated by broken-line AY. As is evident from FIG. 16B, on the whole, the quadrotor autonomous UAV 10 maintained and followed the target flight trajectory TY with greater accuracy in the sensed autonomous mode of use (SAY) compared to the autonomous mode of use (AY).

FIG. 16C presents experimental flight results in graphical form of Z-position and trajectory tracking of the quadrotor autonomous UAV 10. Z-position in meters is plotted on a y-axis, and time in seconds is plotted on an x-axis. In the graph of FIG. 16C, the intended and target flight trajectory with regards to Z-position of the sensed autonomous mode of use is designated by solid-line TZ1; the intended and target flight trajectory with regards to Z-position of the autonomous mode of use is designated by broken-line TZ2; experimental flight results and trajectory with regards to Z-position of the sensed autonomous mode of use of the quadrotor autonomous UAV 10 is designated by solid-line SAZ; and experimental flight results and trajectory with regards to Z-position of the autonomous mode of use of the quadrotor autonomous UAV 10 is designated by broken-line AZ. As is evident from FIG. 16C, on the whole, the quadrotor autonomous UAV 10 in the sensed autonomous mode of use (SAZ) maintained and followed the target flight trajectory TZ1 with greater accuracy compared to the quadrotor autonomous UAV 10 in the autonomous mode of use (AZ) and its following of the target flight trajectory TZ2.

As used herein, the terms “general” and “generally” and “substantially” are intended to account for the inherent degree of variance and imprecision that is often attributed to, and often accompanies, any design and manufacturing process, including engineering tolerances—and without deviation from the relevant functionality and intended outcome—such that mathematical precision and exactitude is not implied and, in some instances, is not possible. In other instances, the terms “general” and “generally” and “substantially” are intended to represent the inherent degree of uncertainty that is often attributed to any quantitative comparison, value, and measurement calculation, or other representation.

It is to be understood that the foregoing description is of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of controlling navigation of an autonomous unmanned aerial vehicle (UAV), the method comprising:
providing the autonomous UAV with at least one rotor, a wind sensor, and a controller;
estimating a thrust force at the at least one rotor, the estimation of the thrust force involving geometric properties of the at least one rotor;
measuring wind via the wind sensor; and
controlling navigation of the autonomous UAV with the use of feedforward flight control at the controller and based at least in part upon the estimated thrust force and the wind measurements.

2. The method as set forth in claim 1, further comprising estimating a rotor drag force at the at least one rotor, the estimation of the rotor drag force involving geometric properties of the at least one rotor, and controlling navigation of the autonomous UAV with the use of feedforward flight control at the controller and based at least in part upon the estimated rotor drag force, the estimated thrust force, and the wind measurements.

3. The method as set forth in claim 2, wherein the estimation of the thrust force is via a first physics-based mathematical model, and the estimation of the rotor drag force is via a second physics-based mathematical model.

4. The method as set forth in claim 1, wherein the geometric properties involved in the estimation of the thrust force comprise at least one of blade twist angle, chord distribution, chord length, number of blades, rotor hub radius, or rotor radius.

5. The method as set forth in claim 3, wherein estimating the thrust force involves revolutions per minute (RPM) of the plurality of rotors and involves flight state parameters of the autonomous UAV.

6. The method as set forth in claim 2, wherein estimating the rotor drag force involves experimental data of rotor forces.

7. The method as set forth in claim 2, wherein estimating the thrust force is performed onboard the autonomous UAV and amid flight of the autonomous UAV, and estimating the rotor drag force is performed onboard the autonomous UAV and amid flight of the autonomous UAV.

8. The method as set forth in claim 1, further comprising controlling navigation of the autonomous UAV based at least in part upon a formulated relationship between the RPM measurements and corresponding throttle input data.

9. The method as set forth in claim 8, wherein the formulated relationship between the RPM measurements and corresponding throttle input data involves experimental data of rotor forces.

10. An autonomous unmanned aerial vehicle (UAV), comprising:
at least one rotor;
a wind sensor carried by the autonomous UAV; and
a controller carried by the autonomous UAV and using feedforward flight control, the feedforward flight control employing a first physics-based mathematical model to estimate a thrust force at the at least one rotor, and the feedforward flight control employing a second physics-based mathematical model to estimate a rotor drag force at the at least one rotor, the estimations of the thrust force and rotor drag force involving geometric properties of the at least one rotor, wherein the feedforward flight control uses wind measurements received from the wind sensor and uses the first and second physics-based mathematical models in order to provide flight control commands for navigation of the autonomous UAV.

11. The autonomous unmanned aerial vehicle (UAV) as set forth in claim 10, wherein the wind sensor measures horizontally-directed wind and measures vertically-directed wind, and the wind measurements received by the controller comprise the horizontally-directed wind and the vertically-directed wind.

12. The autonomous unmanned aerial vehicle (UAV) as set forth in claim 10, wherein the estimated thrust force is for forward flight of the autonomous UAV and is for axial flight of the autonomous UAV.

13. The autonomous unmanned aerial vehicle (UAV) as set forth in claim 10, wherein the geometric properties of the at least one rotor comprise at least one of a blade twist angle, chord distribution, chord length, number of blades, rotor hub radius, or rotor radius.

14. The autonomous unmanned aerial vehicle (UAV) as set forth in claim 10, wherein the estimation of the thrust force involves revolutions per minute (RPM) of the at least one rotor and involves flight state parameters of the autonomous UAV.

15. The autonomous unmanned aerial vehicle (UAV) as set forth in claim 10, wherein the estimation of the rotor drag force involves experimental data of rotor forces.

16. The autonomous unmanned aerial vehicle (UAV) as set forth in claim 10, wherein the feedforward flight control uses RPM measurements of the at least one rotor amid use of the autonomous UAV and uses throttle input data corresponding to the RPM measurements in order to provide flight control commands for navigation of the autonomous UAV.

17. The autonomous unmanned aerial vehicle (UAV) as set forth in claim 10, wherein the controller uses feedback flight control in order to provide flight control commands for navigation of the autonomous UAV.

18. The autonomous unmanned aerial vehicle (UAV) as set forth in claim 10, wherein the estimations of the thrust force and the rotor drag force are used in feedforward flight control and control outputs are calculated onboard the autonomous UAV.

19. A method of controlling navigation of an autonomous unmanned aerial vehicle (UAV), the method comprising:
providing the autonomous UAV with at least one rotor, a wind sensor, and a controller;
estimating a thrust force of the autonomous UAV at the at least one rotor, wherein estimating the thrust force is performed onboard the autonomous UAV;
estimating a rotor drag force of the autonomous UAV at the at least one rotor, wherein estimating the rotor drag force is performed onboard the autonomous UAV;
measuring wind via the wind sensor; and
controlling navigation of the autonomous UAV with the use of feedforward flight control at the controller and based at least in part upon the estimated thrust force, the estimated rotor drag force, the wind measurements, and a formulated relationship between RPM measurements and corresponding throttle input data.

20. The method as set forth in claim 19, wherein estimating the thrust force involves revolutions per minute (RPM) of the at least one rotor, involves flight state parameters of the autonomous UAV, and involves at least one of blade twist angle, chord distribution, chord length, number of blades, rotor hub radius, or rotor radius; wherein estimating the rotor drag force involves experimental data of rotor forces; and wherein the formulated relationship between the RPM measurements and corresponding throttle input data involves experimental data of rotor forces.
